(19) United States
(12) Patent Application Publication
(10) Pub. No.: US 2012/0259693 A1
(43) Pub. Date: Oct. 11, 2012

(54) SYSTEM AND METHOD OF ADMINISTERING A LOYALTY-BASED INCENTIVE REWARDS PROGRAM

(76) Inventor: NGON DONG DAO, Watertown, MA (US)

(21) Appl. No.: 13/080,145

(22) Filed: Apr. 5, 2011

(51) Int. Cl. G06Q 30/00

(52) U.S. Cl. 705/14.27

(57) ABSTRACT

Technologies are described herein for providing loyalty-based incentives to existing customers of a business participating in a loyalty-based incentive rewards program. In one aspect, a computer-implemented method for providing loyalty-based incentives is described. The incentive rewards system administering an incentive rewards program determines whether a customer of a business participating in the incentive rewards program is eligible for a loyalty-based incentive redeemable at the business. Upon determining that the customer is eligible for the loyalty-based incentive, a maximum redemption value of the loyalty-based incentive for which the customer is eligible is determined based on a previous transactional activity of the customer with the participating business. Consideration is received in exchange for providing the loyalty-based incentive to the customer and then the customer is provided with the loyalty-based incentive having a redemption value not exceeding the maximum redemption value.

### TECHNICAL FIELD

The present disclosure is related to the field of incentive rewards programs. More particularly, the present disclosure is related to the field of loyalty-based incentive rewards programs.

### BACKGROUND

Incentive rewards programs are becoming increasingly popular amongst businesses as a way to attract new customers and retain existing customers. As a result, some businesses are either launching their own incentive rewards programs or participating in multi-business incentive rewards programs administered by independent companies that provide customers incentives that are redeemable at any of the participating businesses. Examples of incentive rewards programs administered by independent companies include the American Express Membership Rewards program and the OpenTable Dining Rewards system.

One problem some businesses face when launching their own incentive rewards programs is the cost and complexity of marketing and administering an incentive rewards program. Additionally, businesses that launch their own incentive rewards programs may find it difficult to attract new customers through their own incentive rewards program due to the business's inability to market to customers of other businesses.

Instead of launching their own incentive rewards programs, some businesses may participate in a multi-business incentive rewards program administered by an independent company in an attempt to get wider exposure while avoiding the time and money spent on administering an incentive rewards program. However, existing multi-business incentive rewards programs administered by independent companies are somewhat ineffective in increasing customer retention at the participating businesses. This is because these incentive rewards programs allow customers to earn rewards from any participating business and then redeem the earned rewards at any other participating business or from a common redemption pool. For instance, the OpenTable reservation system administers an incentive rewards program that awards points to diners for dining at restaurants that are participating in the OpenTable reservation system. These points, however, are redeemable at any of their member restaurants without restriction. As a result, diners are not directly incentivized to return to the same restaurant through which the points were awarded. Rather, the diners may redeem their diner points at any of the other member restaurants that are participating in the incentive rewards program administered by the OpenTable reservation system. Although the diners may appreciate the flexibility in redeeming their diner points, participating businesses find that these systems do not significantly help increase repeat business as the customers may likely want to use their diner points to try different restaurants.

It is with respect to these and others considerations that the disclosure made herein is presented.

### SUMMARY

Technologies are described herein for administering a loyalty-based incentive rewards program that provides loyalty-based incentives to existing customers of a business participating in an incentive rewards program. Loyalty-based incentives, such as discount coupons, can provide customers of a business an incentive to return to the business as a repeat customer. By way of the present disclosure, an incentive rewards program can provide loyalty-based incentives to customers of a participating business that are redeemable only at the participating business or are redeemable through a redemption program specific to the participating business. In doing so, businesses are able to offer their customers loyalty-based incentives that incentivize the customer to return to the participating business as repeat customers.

The incentive rewards program is administered by an independent incentive rewards system. A business may participate in the incentive rewards program upon reaching an incentive agreement with the incentive rewards system. The incentive agreement may include provisions that allow the incentive rewards system to generate, provide, and in some instances, sell loyalty-based incentives that are redeemable at the participating business or redeemable through the redemption program specific to the participating business to existing customers of the participating business.

In one aspect, a computer-implemented method for providing loyalty-based incentives is described. The incentive rewards system administering an incentive rewards program determines whether a customer of a business participating in the incentive rewards program is eligible for a loyalty-based incentive redeemable at the business. Upon determining that the customer is eligible for the loyalty-based incentive, a maximum redemption value of the loyalty-based incentive for which the customer is eligible is determined based on a previous transactional activity of the customer with the participating business. Consideration is received in exchange for providing the loyalty-based incentive to the customer and then the customer is provided with the loyalty-based incentive having a redemption value not exceeding the maximum redemption value.

It should be appreciated that the above-described subject matter may also be implemented as a computer-controlled apparatus, a computer process, a computing system, or as an article of manufacture such as a computer-readable medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a block diagram illustrating a business environment in which an incentive rewards system administering an incentive rewards program provides loyalty-based incentives to existing customers of participating businesses, according to one or more embodiments presented herein;

FIG. 2 is a block diagram illustrating a loyalty-based incentive rewards system according to one or more embodiments presented herein;

FIG. 3 is a logical flow diagram illustrating a process for providing loyalty-based incentives according to one or more embodiments presented herein;

FIG. 4 is a logical flow diagram illustrating a process for providing loyalty-based incentives to subscribing members and non-members according to one or more embodiments presented herein; and

FIG. 5 is a computer architecture diagram illustrating computing system hardware capable of distributing loyalty based incentives to customers according to one or more embodiments presented herein.

### DETAILED DESCRIPTION

The following description is directed to business process mechanisms for administering a loyalty-based incentive rewards program (hereinafter referred to as ‘the rewards program’) that incentivizes existing customers of a business participating in the rewards program to increase spending at the participating business. An incentive rewards system (hereinafter referred to as ‘the system’) configured to administer the incentive rewards program may allow a business to participate in the rewards program in exchange for consideration. The consideration may include granting the system a right to generate and sell incentives that are redeemable at the business to existing customers of the business.

It should be appreciated that an incentive may include, but is not limited to, a discount, savings, a free or subsidized product or service, a coupon, an experience, an opportunity, a product or service that may or may not otherwise be available for sale, or any benefit that increases customer value proposition. Furthermore, the incentives may have a redemption value, which may be based on the existing customer's previous transactional activity with the particular business. The redemption value of the incentive is the value of savings that the incentive provides to the customer at the time of redemption.

According to embodiments of the present disclosure, the system may provide a network-based platform through which customers may request to receive one or more incentives redeemable at a participating business from the loyalty-based incentive rewards program. The system, upon receiving the request from the customer, may determine whether the customer qualifies for any incentives by retrieving and analyzing the customer's previous transactional activity with the business. If the system determines that the customer qualifies for an incentive, the system may determine a maximum redemption value of the incentive for which the customer qualifies. This determination is based, in part, on the customer's previous transactional activity with the business. In other embodiments, the participating business or the incentive rewards system may proactively offer incentives for which the existing customer is eligible to the existing customer.

Upon determining the maximum redemption value of the incentive, the system may then offer to sell incentives that have corresponding redemption values that do not exceed the determined maximum redemption value. The system then determines the purchase price of the incentives. Of course, this purchase price is less than the redemption value of the incentive. The system may then present the incentives and their corresponding purchase prices to the customer. The customer may purchase one or more incentives by making a payment to the system. Once the purchase is complete, the system provides the customer the purchased incentives, which the customer may redeem at the business during a subsequent transaction.

Because the maximum redemption value of an incentive is based on the customer's previous transactional activity with the business, a customer is incentivized to spend more money at the business to earn greater incentives. Furthermore, because these incentives are redeemable during subsequent transactions, the customer is incentivized to return to the business as a repeat customer. In this way, the business process mechanisms presented herein allow businesses to increase sales while building customer loyalty. Customers, too, benefit by getting a better value proposition.

While the subject matter described herein is presented in the general context of program modules that execute in conjunction with the execution of an operating system and application programs on a computer system or embedded processor system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

In the following detailed description, references are made to the accompanying drawings that form a part hereof, and which are shown by way of illustration, as specific embodiments, or examples. Referring now to the drawings, in which like numerals represent like elements through the several figures, aspects of a business process mechanism implementing a computing system and methodology for administering a loyalty-based incentive rewards program that incentivizes existing customers of a business participating in the loyalty-based incentive rewards program to increase spending at the participating business will be described.

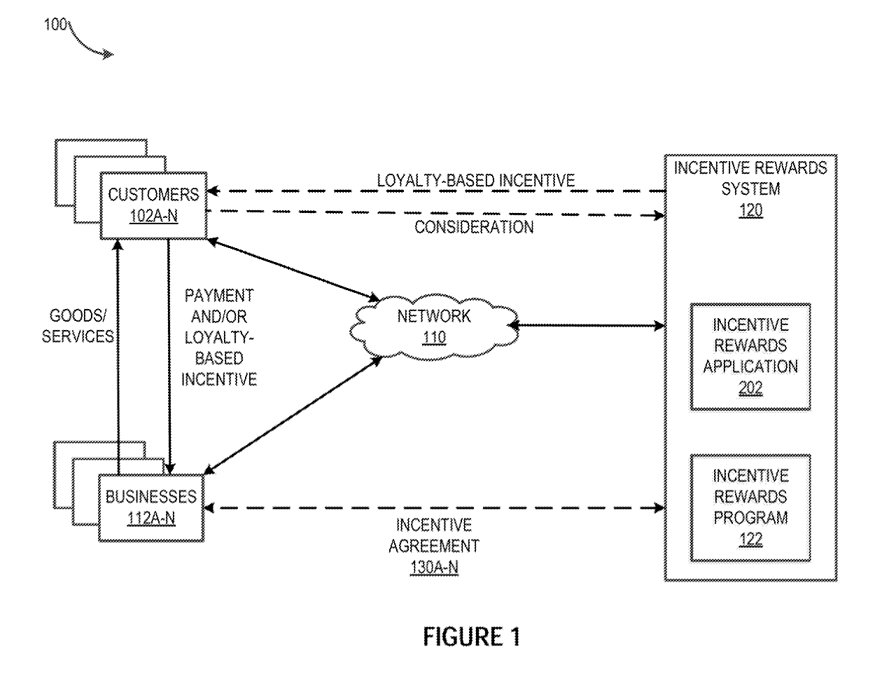

FIG. 1 is a block diagram illustrating a business environment in which a system, such as an incentive rewards system, administering an incentive rewards program may provide loyalty-based incentives to existing customers of businesses, according to one or more embodiments of the technology presented herein. In particular, a business environment 100 may include one or more customers 102A-N, generally referred to herein as customers 102 of one or more businesses 112A-N, which are generally referred to herein as businesses 112. A customer 102 may purchase goods or services from a business 112 in exchange for consideration. The consideration typically includes the transfer of money. However, in some embodiments of the present disclosure, the consideration may include the redemption of a loyalty-based incentive at the business 112 along with or without the transfer of money. In other embodiments, the consideration may be a non-monetary exchange of value. For instance, the consideration may include the customer providing the business access to the customer's social network, the customer filling a survey, the customer sharing an incentive with their friends, or any other reasonable type of consideration known to people skilled in the art. Furthermore, the consideration may be provided by a third-party that is willing to provide consideration to the incentive rewards system 120 in exchange for advertising, marketing, data collection, or any other purpose that may appeal to a third-party.

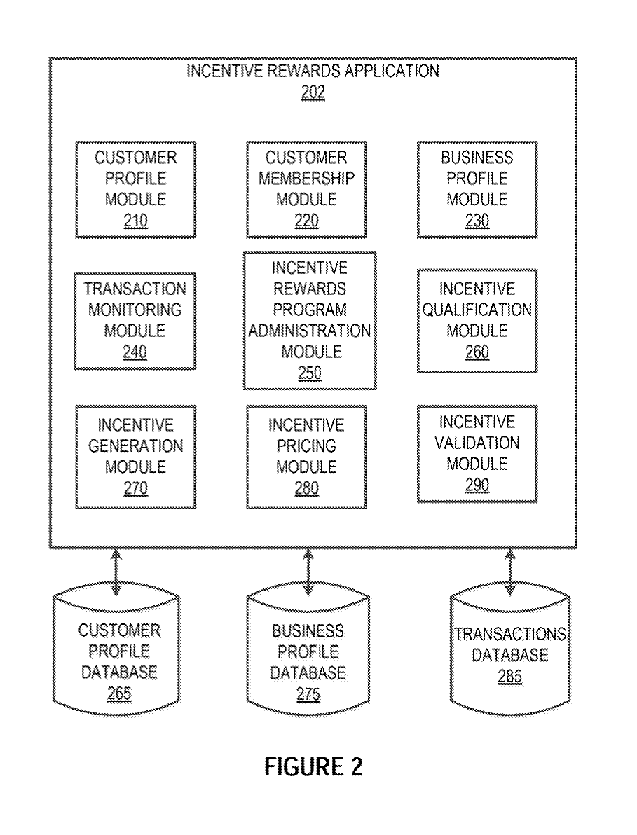

The customer 102 may receive the loyalty-based incentive from an incentive rewards system 120. The loyalty-based incentive rewards system 120, generally referred to herein as the system 120, may be configured to administer a loyalty-based incentive rewards program 122, generally referred to herein as the incentive rewards program 122. The incentive rewards program 122 may be administered by the incentive rewards system 120 via an incentive rewards application 202, which may include computer-readable code, which when executed by a computer, causes the computer to administer the incentive rewards program 122. Additional details regarding the incentive rewards application 202 are provided below with respect to FIG. 2.

The incentive rewards system 120 may be an independent business entity that may be configured to administer the incentive rewards program 122 that provides business-specific loyalty-based incentives that are redeemable at the businesses 112. A business-specific loyalty-based incentive is a value proposition benefit that may be issued to an existing customer of a specific business for redemption at the specific business.

As described above, businesses 112 may find it desirable to participate in the incentive rewards program 122 for boosting sales and customer retention. The businesses 112 may participate in the incentive rewards program 122 by registering with the incentive rewards system 120. A business 112 may be required to enter into a contractual relationship, such as a business-specific incentive agreement 130A-N, with the incentive rewards system 120. The incentive agreement 130 may include terms or provisions that grant the incentive rewards system 120 the right to generate and provide, for consideration or otherwise, business-specific loyalty-based incentives to existing customers 102 of the business 112.

It should be appreciated that each business-specific incentive agreement 130 may include terms or provisions that are different from other incentive agreements that exist between other participating businesses 112 and the incentive rewards system 120. This makes sense as different businesses may have different goals, profit margins, services, capabilities and the like. As such, each business-specific incentive agreement 130 may also include provisions that outline a type of loyalty-based incentive and a maximum redemption value of the loyalty-based incentive that the incentive rewards program 122 can provide to the existing customers 102 of the participating businesses 112.

As briefly described above, an incentive may include, but is not limited to, a discount, savings, a free or subsidized product or service, a coupon, an experience, an opportunity, a product or service that may or may not otherwise be available for sale, or any benefit that increases customer value proposition. Furthermore, the incentives may have a redemption value, which may be based on the existing customer's previous transactional activity with the particular business. The redemption value of the incentive is the value of a benefit that the incentive provides to the customer at the time of redemption. For the sake of clarity, if the incentive is a ‘$5 off next purchase’ coupon, the customer saves $5 when the incentive is redeemed. Therefore, the redemption value of the $5 off next purchase coupon is $5. Similarly, if the incentive is a coupon for a ‘free egg roll on next purchase’, the redemption value of the incentive is the normal selling price of the egg roll. If the incentive is a coupon for ‘10% off next purchase’, the redemption value of the incentive is the value of a benefit the customer will receive when the loyalty-based incentive is redeemed. If the customer purchased an item worth $100, the redemption value of a coupon for ‘10% off next purchase’ is $10. In such incentives, where the customer receives a percentage off the total purchase price, the incentive may have a maximum redemption value if the incentive has a restriction. For instance, a coupon for ‘10% off any items of $100 or less’. In such cases, the maximum redemption value of the incentive is $10 and the redemption value of the incentive cannot exceed $10.

As briefly mentioned above, the maximum redemption value of an incentive for which a customer is eligible is based, in part, on the customer's previous transactional activity with the business. The customer's previous transactional activity includes the customer's previous payments, the frequency of the customer's visits, the type of purchases the customer makes, and any other information regarding the transactions the customer makes with a business. In some embodiments, this may even include efforts made by the customer to bring in new customers. By rewarding customers based on their previous transactional activity, customers are incentivized to spend more.

For instance, in some embodiments, a first provision in the incentive agreement 130 may allow the incentive rewards system 120 to provide an incentive having a maximum redemption value equaling 10% on previous unrewarded payments made to the business 112. Unrewarded payments may be those payments made by the customer for which the customer has not received and/or redeemed an incentive. A second provision in the incentive agreement 130 may allow the incentive rewards system 120 to provide a customer a referral incentive having a maximum redemption value equaling 5% on previous payments made by a referee customer who was referred by the customer. A third provision in the incentive agreement 130 may allow the incentive rewards system 120 to provide a customer a frequency incentive having a maximum redemption value of 2% of previous payments made by the customer within a specific time period. A fourth provision in the incentive agreement 130 may allow the incentive rewards system 120 to provide a customer a length of relationship incentive having a maximum redemption value of 1% of previous payments made after a specific time after customer's initial purchase. These provisions may all fall under the umbrella of a loyalty-based incentive. It should be appreciated that other milestones achieved by the customer or actions taken by the customer may also be part of the customer's previous transactional activity with the business 112. Furthermore, additional provisions may adjust the maximum redemption value percentage for each of these types of incentives upon reaching certain purchase-based or time-based milestones. Other provisions may outline restrictions on the generation, distribution, redemption, and sale of the incentives that may be provided by the incentive rewards system 120 to the customers 102.

It should further be appreciated that the customer 102 may redeem a portion of the maximum redemption value of the incentive despite being able to receive an incentive having a greater redemption value. This may be desirable if the customer decides to ration the available incentives over a series of transactions. For instance, the table 1 below illustrates a sequence of transactions performed by the customer at a particular business. The table includes various columns that further explain how the maximum redemption value of an incentive may be calculated and how incentives having a redemption value less than or equal to the maximum redemption value are redeemed. It should further be understood that the table depicts an example embodiment of a sequence of transactions, and the scope of the present disclosure, is in no way intended to be limited to this example embodiment.

TABLE 1

| | | | | | | | H |
|---|---|---|---|---|---|---|---|
| | | | | | | | Cumulative |
| | B | | | E | F | G | maximum |
| | Cost of | C | D | Amount | Cumulative | Cumulative | redemption value |
| | Product or | Did | Redemption | paid by | amount | amount of | of incentive |
| A | Service | customer | value of | customer | spent by | incentives | available to |
| ID | at each | redeem | incentive | at each | customer | earned | customer |
| # | transaction | incentive | redeemed | transaction | F_{N} = Σ E_{1-N} | G = 0.1* F | H_{N} = G_{N} − (ΣD_{1-N}) |
| 1 | 50 | — | — | 50 | 50 | 5 | 5 |
| 2 | 100 | N | 0 | 100 | 150 | 15 | 15 |
| 3 | 30 | Y | 10 | 20 | 170 | 17 | 7 |
| 4 | 57 | Y | 7 | 50 | 220 | 22 | 5 |
| N | 5 | Y | 5 | 0 | 220 | 22 | 0 |

It should further be understood that although the customer is eligible for an incentive having a redemption value of up to a maximum eligible redemption value, the incentive rewards system 120 may sell the customer 102 an incentive that has a redemption value that is less than the maximum eligible redemption value. In some embodiments, the incentive rewards system 120 may further be configured to provide the customer 112 an incentive having the maximum eligible redemption value only if the customer subscribes as a member of the incentive rewards system 120. As discussed herein, the incentive rewards system 120 may be configured to control the distribution, prices, and availability of the loyalty-based incentives to the existing customers 102. Through this control, the incentive rewards system 120 may sell incentives having different redemption values at different prices, and may withhold incentives having certain redemption values for members who pay a subscription fee. In some embodiments, the members may be able to purchase the incentives at a member-price while non-members may be able to purchase the incentives at a non-member price that is greater than the member-price.

Still referring to FIG. 1, the customers 102, the businesses 112 and the incentive rewards system 120 may be communicatively connected to one another via a network 110. It should be appreciated by those skilled in the art that the network 110 may include, but not limited to the INTERNET, a LAN, a WAN, or any combination thereof. Furthermore, the network may be a wired network or wireless network, such as a cellular network that may allow the customers 102, the businesses 112, and the incentive rewards system 120 to communicate with one another.

The customers 102 may be able to communicate with the incentive rewards system 120 via the network 110 using customer devices. A customer device may be a mobile phone, a personal computer, such as a desktop or a laptop, a tablet, or any other computing device capable of communicating with the incentive rewards system 120. In some embodiments, the customers may utilize their customer devices to access a network-based platform provided by the incentive rewards system 120 through which the customer 102 may interact with the incentive rewards system 120. According to some embodiments, the network-based platform is provided by the incentive rewards application 202 and may be accessible by the customers 102 through a website, a web-based application or a mobile application.

Referring now to FIG. 2, a block diagram illustrates the incentive rewards application 202, according to one or more embodiments of the technology presented herein. The incentive rewards application 202 may include one or more modules that may be configured to perform various functions, tasks, responsibilities, and the like. According to some example embodiments, the incentive rewards application 202 may include a customer profile module 210, a customer membership module 220, a business profile module 230, a transaction monitoring module 240, an incentive rewards program administration module 250, an incentive qualification module 260, an incentive generation module 270, an incentive pricing module 280, an incentive validation module 290, amongst others. The incentive rewards application 202 may also be configured to communicate with one or more databases, such as a customer profile database 265, a business profile database 275, and a transactions database 285.

The customer profile module 210 may be configured to manage the customer profile database 265 and the information stored therein. According to embodiments, the customer profile database 265 may include information associated with each of the customers of the incentive rewards system 120. A customer of the incentive rewards system 120 is a person or entity that has made a purchase from the incentive rewards system 120. The information may include identification information of the customer, including the customer's name, address, contact information, including but not limited to a phone number, an email address, and any social media contact information. In addition, the customer profile database 265 may include information pertaining to a customer device associated with the customer. In this way, any communication with the customer may be conducted in a format that is compatible with the type of customer device. For instance, if the customer device is a smart phone, the incentive rewards application 202 may be able to provide incentives, such as coupons, to the customer via email, SMS messages, or via a mobile application installed on the smart phone. Furthermore, the customer profile module 210 may also be configured to manage information associated with customers 102 of any of the participating businesses 112. According to embodiments, either the customer 102 or any of the participating businesses 112 may provide information, including transactional activity, pertaining to the customer 102 to the customer profile database 265.

The customer membership profile module 220 may be configured to manage membership information of customers 102. According to some embodiments, the incentive rewards system 120 may allow customers 102 to subscribe as members of the incentive rewards system 120. As members, the customers 102 may be able to purchase the loyalty-based incentives at subsidized prices or may receive the loyalty-based incentives for free. In other embodiments, a member may be provided a certain number of free loyalty-based incentives over a given time period. For instance, the member may be entitled to receive three free incentives per calendar month. In other embodiments, members may be eligible to receive loyalty-based incentives that have fewer restrictions than loyalty-based incentives provided to non-members. Alternatively, members may be eligible to receive exclusive loyalty-based incentives that are not available to non-members.

The business profile module 230 may be configured to manage the business profile database 275 and the information associated with the businesses 112 stored therein. The business profile database 275 may include a list of businesses 112 that are participating in the incentive rewards program 122. For each of the businesses 112, the business profile database 275 may include information about the type of business, a list of customers 102 transacting with the business, and information about any incentives associated with the business. In addition, the business profile database 275 may include an incentive agreement between the business 112 and the incentive rewards system 120. Additional details of the incentive agreement are provided below during a discussion of the incentive rewards program administration module 250.

The transaction monitoring module 240 may be configured to monitor transactions being conducted between participating businesses 112 and their customers 102. According to embodiments, the transaction monitoring module 240 may be configured to receive information pertaining to each transaction between the participating businesses 112 and their customers 102 from the participating businesses 112 or the customers. According to some embodiments, the transaction monitoring module 240 may be configured to retrieve the information pertaining to each transaction between the participating businesses 112 and their customers 102 by receiving transactional information submitted by the participating businesses 112 to the incentive rewards system 120. In alternate embodiments, the transaction monitoring module 240 may be able to retrieve transactional information from the customer. According to embodiments, the incentive rewards system 120 may have permission to monitor the customer's payment accounts to identify transactions made at participating businesses 112. In some embodiments, the customer 102 may be able to send an image of a receipt of the transaction to the incentive rewards system 120. Upon receiving the image of the receipt, the transaction monitoring module 240 may be able to identify relevant information pertaining to the transaction and store it in the transactions database 285. The information received by the incentive rewards system 120 may then be stored in the transactions database 285.

The incentive rewards program administration module 250 may be configured to administer the incentive rewards program 122. In particular, the incentive rewards program administration module 250 may be configured to register businesses 112 that wish to participate in the incentive rewards program 122. The registration process requires that the business 112 enter into an incentive agreement with the incentive rewards system 120. As described above, the incentive agreement may include terms and provisions for allowing the incentive rewards system 120 to provide loyalty-based incentives to existing customers 102 of the business 112. The terms may include details about the type of loyalty-based incentives, the value of the loyalty-based incentives, and the restrictions on redeeming the loyalty-based incentives, amongst others.

The incentive rewards program administration module 250 may also be configured to receive requests for incentives from customers 102 of the incentive rewards system 120. Upon receiving the requests, the incentive rewards program administration module 250 may be configured to invoke the incentive qualification module 260, which determines whether the customer 102 requesting the incentive qualifies for an incentive.

The incentive qualification module 260 may be configured to determine whether the customer 102 qualifies for an incentive. In particular, the incentive qualification module 260 may analyze the customer's previous transactional activity with the participating business 112 for which the customer 102 has requested an incentive. According to embodiments, the incentive rewards system 120 may allow a customer to qualify for an incentive as long as the customer is an existing customer of the participating business. According to some embodiments, the incentive qualification module 260 may also be configured to determine the maximum redemption value of an incentive the customer is eligible to receive. This determination may be made by analyzing the customer's previous transactional activity with the participating business. The incentive qualification module 260 may then notify the incentive rewards program administration module 250 of the findings.

The incentive rewards program administration module 250 may also be configured to invoke the incentive generation module 270 to generate an incentive corresponding to the customer's previous transactional activity with the participating business. The incentive generation module 270 may be configured to generate a loyalty-based incentive that may have a maximum redemption value determined by the incentive qualification module 260.

The incentive pricing module 280 may be configured to determine a purchase price at which a loyalty-based incentive generated by the incentive generation module 270 is offered for sale to an existing customer 102 of the participating business 112. In some embodiments, the incentive generation module 270 may generate multiple loyalty-based incentives, each of which may have a different redemption value that does not exceed the maximum redemption value determined by the incentive qualification module 260 in accordance with the provisions of the incentive agreement 130. The incentive pricing module 280 may then determine a purchase price for each of the incentives generated by the incentive generation module 270. Typically, the purchase price of an incentive is less than the maximum redemption value of the loyalty-based incentive. Further, in embodiments where the incentive rewards system 120 allows customers 102 to subscribe as members, the purchase price of the incentive offered to members may be even lower than the purchase price offered to non-members.

It should be appreciated that the incentive rewards application 202 may include additional modules to perform other functions. For instance, the incentive rewards application may also include an incentive validation module 290 configured to validate the incentives provided to the businesses 112 for redemption by the customers 102. According to embodiments, the incentive validation module 290 may be configured to validate a loyalty-based incentive provided to the business 112 for redemption. The incentive validation module 290 may do so by receiving an incentive code from the business 112, determining if the incentive code matches an incentive code associated with the loyalty-based incentive generated by the incentive rewards system 120, and upon determining that the incentive code matches the incentive code associated with the loyalty-based incentive, sending a validation notification to the business 112 indicating that the incentive is valid. Once the loyalty-based incentive is redeemed, the incentive rewards system 120 may make a notification that the loyalty-based incentive has been redeemed and no longer valid for redemption.

In addition to the modules described above, the incentive rewards application may be configured to receive transaction information corresponding to a transaction between a customer and a candidate business that is not currently registered with the incentive rewards system to participate in the incentive rewards program. The incentive rewards system may utilize this information to gauge interest in pursuing the candidate business as a candidate to participate in the incentive rewards program. As such, the incentive rewards system may encourage customers to provide transaction information corresponding to a transaction between a customer and a candidate business so that it can accumulate transactions corresponding to the candidate business. According to embodiments, the transaction information corresponding to transactions between the customer and the candidate business may be stored in the transactions database 285.

According to embodiments, the incentive rewards application 202 may be configured to determine if a threshold number of transactions corresponding to the candidate business have been reported to the incentive rewards program 122. One way of determining this is by determining the number of transactions corresponding to the candidate business stored in the transactions database 285. Upon determining that a threshold number of transactions corresponding to the candidate business are stored in the transactions database 285, the incentive rewards application 202 may be configured to notify a sales representative of the incentive rewards system 120 that a threshold number of transactions corresponding to the candidate business have been reported to the incentive rewards program 122. In this way, the sales representative can prepare a sales pitch and approach the candidate business to participate in the incentive rewards program.

Traditional loyalty-based systems do not reward customers who express to others their commitment to return even though such an expression is more telling than just recommending a particular business to others. Moreover, existing loyalty-based systems do not incentivize users to share their earned rewards with others. Furthermore, existing loyalty-based systems are not fun or exciting, and fail to implement an element of surprise that may encourage customers to discuss the loyalty system with their friends. With respect to these and other shortcomings of existing loyalty-based systems, the present disclosure provides aspects to incentivize customers to increase sales at a particular business. The following are a few example embodiments that describe novel, innovative, methodologies to incentivize existing customers and new customers for increasing sales at the particular business.

In a first example, a customer 102 may enter a business 112 and makes a transaction. Upon making a purchase, the incentive rewards system 120 logs the transaction and records a reward that has a maximum redemption value based on the previous transactional activity between the customer 102 and the business 112 into a virtual bank account of the customer 102. This virtual bank account is managed by the incentive rewards system 120, and keeps track of the maximum redemption value of an incentive for which the customer 102 is eligible. This virtual bank account is updated as more transactional activity between the customer 102 and the business 112 occurs. In this way, when the customer 102 returns to the business 112 for a subsequent transaction, the customer 102 is eligible to receive an incentive up to the maximum redemption value from the incentive rewards system 120 in exchange for consideration. This consideration may be in the form of money, or in some embodiments, sharing a link with the customer's social network, providing the incentive rewards system 120 access to the customer's social networks. In some embodiments, the consideration may be provided by a third-party, such as an advertiser or marketer. In this embodiment, the customer 102 is rewarded for returning to the business 104 as a repeat customer by being eligible to redeem a loyalty-based incentive.

According to a second example, the incentive rewards system 120 may introduce the element of perishability to encourage future commitments from the customer 102. In this example, the incentive rewards system 120 may be configured to gather information, either from the customer 102, the business 112, or through other reasonable means, about a transaction made by the customer 102 at the business 112. The incentive rewards system 120 may then present the customer 102 an option to purchase a loyalty-based incentive. However, the option to purchase the loyalty-based incentive may have an expiration time of say, 1 hour, after which the customer 102 is ineligible to purchase the loyalty-based incentive. In some embodiments, the customer 102 may be incentivized to purchase the loyalty-based incentive within the expiration time by offering a lower purchase price relative to a purchase price that the customer 102 may be offered after the expiration time has expired. In this way, the incentive rewards system 120 introduces the concept of perishability to incentivize the customer 102 to make a future commitment shortly after the customer's last transaction. This helps boost customer retention as it provides a way for the business to commit the customer to come in as a repeat customer.

According to a third example, the incentive rewards system 120 may include the concept of virality to incentivize the customer 102 to share an incentive with the customer's social network. To help understand the concept of virality, the following scenario is provided. A customer makes a purchase for $30. The incentive rewards system 120 determines that the customer has made this purchase and presents the customer with an incentive to return to the business as a repeat customer. Typically, this incentive is based on the customer's previous transactional activity with the business. Say, the incentive rewards system offers the customer a loyalty-based incentive that has a redemption value of $3 at a purchase price of $1. A lot of customers may not bother to make a purchase to obtain a redemption value as small as $3. Therefore, to incentivize customers, the incentive rewards system 120 may provide the customer an option to earn an incentive that has a greater redemption value than $3. According to embodiments, the incentive rewards system 120 may allow the customer to invite the customer's friends (or social connections) to buy the same incentive at the same purchase price. There may be a cap on the number of friends the customer may invite or on the number of incentives that the customer's friends can purchase. For instance, for each friend, up to a maximum of 5 friends, that purchases the same incentive, the customer's maximum redemption value may multiply by the number of friends that purchased the same incentive. In this way, the customer may be able to earn a loyalty-based incentive that has a redemption value of $15.

Still referring to the scenario described above, in some embodiments, the incentive rewards system 120 may further incentivize friends of the customer to act on the offer by implementing a chain multiplier concept. According to embodiments of the chain multiplier concept, if five friends buy the same incentive, the customer may receive an incentive that has a redemption value of $15. Unlike in embodiments that do not implement the chain multiplier concept, the five friends may only receive an incentive having a redemption value of $3. This may not be an incentive enough for the friends to make a purchase. Accordingly, in embodiments that implement the chain multiplier concept, the first friend to purchase the incentive may receive an incentive having a redemption value of 4 times the original incentive of $3, which is $12. The second friend to purchase the incentive may receive an incentive having a redemption value of 3 times the original incentive of $3, which is $9, while the third friend to purchase the incentive may receive an incentive having a redemption value of 2 times the original incentive of $3, which is $6 and the fourth and fifth friends receive an incentive having a redemption value of $3 each. In some embodiments, the friends may not know how many incentives have been purchased, thereby pressurizing them to act quickly to receive a larger incentive than their friends. It should be appreciated that the friends may be able to share the incentive with other friends and so forth, which will add to the virality of the incentive, as well as have the effect of marketing the business to more people through social networking platforms.

In some embodiments, additional restrictions may be imposed on how the customer may redeem the $15 loyalty-based incentive. For instance, these restrictions may include requiring the friends to redeem the incentive before the customer is able to redeem the incentive. In one example embodiment, the customer's loyalty-based incentive may be limited to a redemption value that is a multiple of the number of friends that have purchased the incentive and redeemed the incentive before the customer redeems their loyalty-based incentive. In this way, the business may be protected from fraud or abuse.

In yet another example, the customer may be able to receive the incentive without buying the incentive if a threshold number of the customer's friends who purchase and/or redeem the incentive is exceeded. In additional examples, a lottery or gaming concept may be introduced to incentivize customers. In some embodiments, the customer may be able to purchase an incentive that has an undisclosed redemption value for a particular price using a lottery, jackpot or other gaming mechanism. In this way, users who may make small transactions may be eligible to potentially earn significant rewards and users are further tempted to participate in such transactions due to the inherent element of surprise in lottery, jackpot, and gaming mechanisms.

In some embodiments, a business may utilize a rewards points system that awards the customer rewards points based on the customer's previous transactional activity with the business. In such embodiments, the customer may be able to purchase an incentive using the rewards points earned through the rewards points system of the particular business. Similarly, the incentive rewards system 120 may also administer a similar rewards points system through which the customer may redeem the rewards points to purchase a loyalty-based incentive that is redeemable at a particular business.

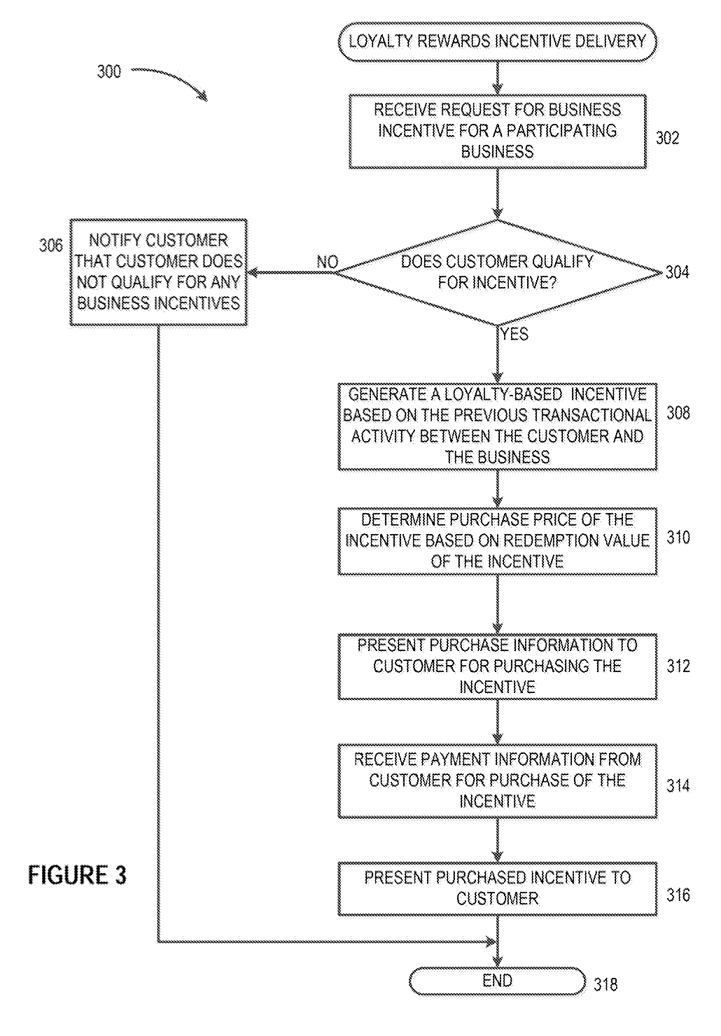

Turning now to FIG. 3, additional details will be provided regarding the embodiments presented herein for providing loyalty-based incentives. In particular, FIG. 3 is a flow diagram showing a routine 300 that illustrates aspects of a process for providing loyalty-based incentives according to one or more embodiments presented herein. It should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as operations, structural devices, acts, or modules. These operations, structural devices, acts and modules may be implemented in software, in firmware, in special purpose digital logic, or any combination thereof. It should also be appreciated that more or fewer operations may be performed than shown in the figures and described herein. These operations may also be performed in parallel, or in a different order than those described herein.

The routine 300 begins at operation 302, where the incentive rewards system 120 receives a request for a loyalty-based incentive from an existing customer 102 of a participating business 112 that is participating in an incentive rewards program 122 administered by the incentive rewards system 120. According to embodiments, the customer 112 may request a loyalty-based incentive through a customer device that is configured to communicate with the incentive rewards system 120 via the network 110. The customer device may be a mobile phone, a personal computer, such as a desktop or a laptop, a tablet, or any other computing device capable of requesting and receiving a loyalty-based incentive. The incentive rewards system 120 may be accessible to the customer device via a website or a mobile application installed on the customer device. In some embodiments, the request may include a request for loyalty-based incentives from a particular business as well for a particular redemption value. It should be appreciated that the incentive rewards system 120 or the participating business may proactively offer the customer incentives based on the customer's previous transactional activity with the business. In this way, even if the customer does not request the incentive, the customer may still be offered the incentive. Furthermore, in some embodiments, the business may be able to determine a purchase price and a maximum redemption value of an incentive for which the customer is eligible, upon which the incentive may be offered to the customer.

From operation 302, the routine 300 proceeds to operation 304, where the incentive rewards system 120 determines whether the customer 102 qualifies for a loyalty-based incentive associated with the particular business 112. According to embodiments, the incentive qualification module 260 may be configured to determine whether the customer 102 qualifies for a loyalty-based incentive for the particular business 112. The determination of whether a customer qualifies for a loyalty-based incentive for the particular business 112 may be based on the incentive agreement 130. According to some embodiments, the incentive agreement 130 may require that the customer 102 have previous transactional activity with the participating business 112 confirming that the customer is an existing customer of the business 112. As described above, the customer's previous transactional activity may be stored in the customer profile database 265, the business profile database 275, and/or the transactions database 285.

If the incentive rewards system 120 determines that the customer 102 does not qualify for a loyalty-based incentive, the routine 300 proceeds from operation 304 to operation 306, where the incentive rewards system 120 notifies the customer 102 that the customer 102 does not qualify for any loyalty-based incentives for the particular business 112. From operation 306, the routine 300 proceeds to operation 318, where the routine 300 ends.

If, at operation 304, the incentive rewards system 120 determines that the customer 102 qualifies for the loyalty-based incentive, the routine 300 proceeds to operation 308, where the incentive rewards system 120 generates one or more loyalty-based incentives in accordance with the incentive agreement 130 in place between the incentive rewards system 120 and the particular business 112. According to embodiments, the incentive generation module 270 may be configured to generate one or more loyalty-based incentives. The incentive qualification module 260 may first determine a maximum redemption value of an incentive that may be provided to the customer 102. In some embodiments, the incentive qualification module 260 may then determine the maximum redemption value by first determining the total amount of money the customer has previously spent at the business 112 from the customer's previous transactional activity. Upon determining the total amount of money the customer 102 has previously spent at the business 112, the incentive generation module 270 may be able to calculate the maximum redemption value based on information included in the provisions of the incentive agreement. Once the maximum redemption value is calculated, the incentive generation module 270 may be configured to generate any number of loyalty-based incentives having a redemption value that does not exceed a maximum redemption value. For example, if the incentive agreement 130 between the business 112 and the incentive rewards system 120 includes a provision that offers a 10% discount on the previous transactional activity between the customer 102 and the business 112 to repeat customers, and the customer has previously spent $100 at the business, the maximum redemption value of the loyalty-based incentive that the customer may be eligible to receive is $10. Accordingly, the incentive generation module 270 may generate a loyalty-based incentive that may have a redemption value up to the maximum redemption value of $10.

From operation 308, the routine 300 proceeds to operation 310, where the incentive rewards system 120 determines a price of the loyalty-based incentive based on the redemption value of the incentive. The redemption value of the incentive is the value of the benefit to the customer at the time of purchase. For instance, an incentive that is a coupon for “$6 off entire purchase” has a redemption value of $6. According to embodiments, the incentive pricing module 280 may be configured to determine a purchase price at which the loyalty-based incentive generated by the incentive generation module 270 can be purchased. According to embodiments, the purchase price of a loyalty-based incentive may be a percentage of the redemption value of the incentive. In some embodiments, the percentage may be 50% of the redemption value of the incentive. Accordingly, the incentive pricing module 280 may determine the price of the coupon for “$6 off entire purchase” to be $3. It should be appreciated that the purchase price of the loyalty-based coupon relative to the redemption value of the loyalty-based incentive may vary based on the pricing strategy of the incentive rewards system 120.

From operation 310, the routine 300 proceeds to operation 312, where the incentive rewards system 120 presents the loyalty-based incentive to the customer 102 for purchase. From operation 312, the routine 300 proceeds to operation 314, where the incentive rewards system 120 receives payment information from the customer 102 for the purchase of the loyalty-based incentive. From operation 314, the routine 300 proceeds to operation 316, where the incentive rewards system 120 provides the loyalty-based incentive to the customer 102 for use at the participating business 112 at which the incentive may be redeemed. From operation 316, the routine 300 proceeds to operation 318, where the routine 300 ends.

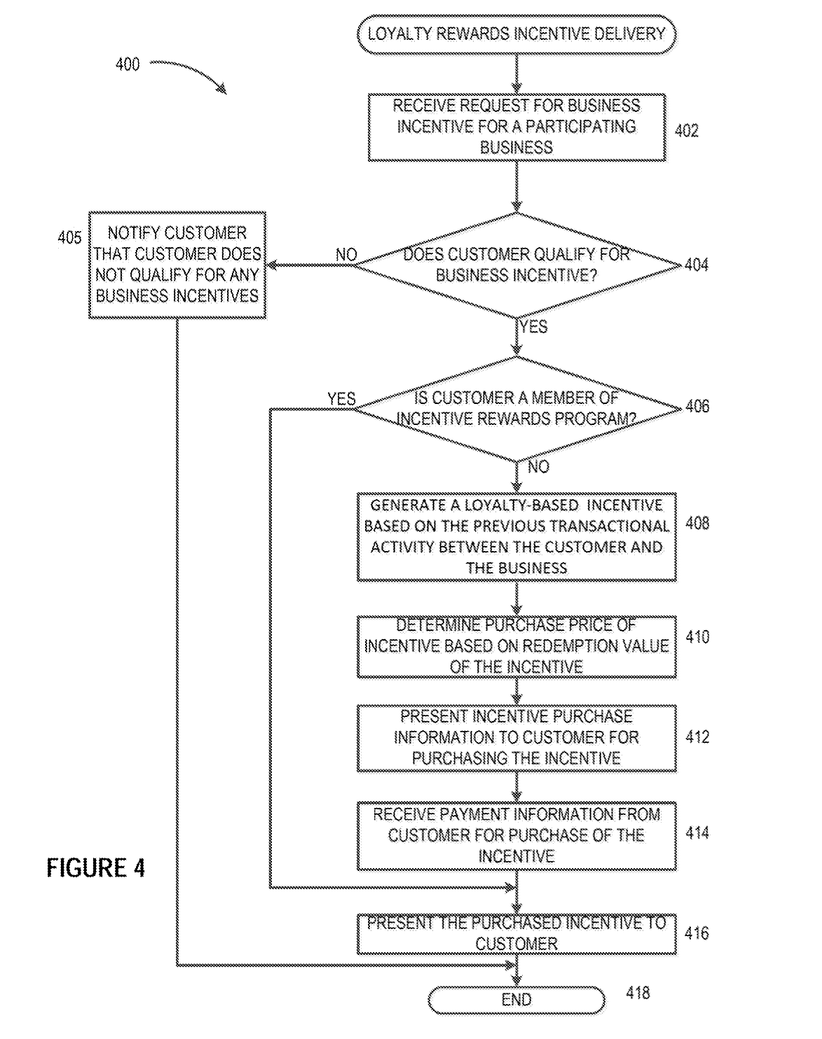

Referring now to FIG. 4, a logical flow diagram illustrating a process for providing loyalty-based incentives to subscribing members and non-members is shown. A routine 400 begins at operation 402, where the incentive rewards system 120 receives a request for a loyalty-based incentive from an existing customer of a participating business 112 that is participating in an incentive rewards program 122 administered by the incentive rewards system 120. From operation 402, the routine 400 proceeds to operation 404, where the incentive rewards system 120 determines if the customer qualifies for the loyalty-based incentive. As described above with respect to FIG. 3, the incentive qualification module 260 may be configured to determine if the customer 102 qualifies for the loyalty-based incentive according to the incentive qualification guidelines laid out in the incentive agreement. If, at operation 404, the incentive qualification module 260 determines that the customer 102 does not qualify for the loyalty-based incentive, the routine 400 proceeds to operation 405, where the incentive rewards system 120 notifies the customer 102 that the customer does not qualify for an incentive. From operation 405, the routine 400 proceeds to operation 418, where the routine 400 ends.

If, however, at operation 404, the incentive qualification module 260 determines that the customer 102 qualifies for a loyalty-based incentive, the routine 400 proceeds from operation 404 to operation 406, where the customer membership module 220 determines if the customer is a member of the incentive rewards system 120. According to embodiments, the customer membership module 220 may determine if the customer is a member of the incentive rewards system 120 by performing a lookup in the customer profile database. According to some embodiments, a customer may become a member of the incentive rewards system 120 by paying a membership fee, which may be a recurring subscription fee or a one-time payment. By becoming a member, the customer may qualify for greater savings by either receiving loyalty-based incentives for free or lower prices than customers who are not members of the incentive rewards program 122.

If, at operation 406, the customer membership module 220 determines that the customer 102 is a member of the incentive rewards system 120, the routine 400 proceeds to operation 414, where the incentive rewards system 120 provides the loyalty-based incentive to the customer without receiving a payment. It should be understood that the incentive rewards system 120 may be able to control the pricing and distribution of the loyalty-based incentives at its discretion. In some example embodiment, the incentive rewards system 120 is configured to provide the loyalty-based incentive to customers 102 who are members of the incentive rewards system 120 for free.

If, at operation 406, the customer membership module 220 determines that the customer 102 is not a member of the incentive rewards system 120, the routine 400 proceeds from operation 406, to operation 408. At operation 408, the incentive generation module 270 may generate one or more loyalty-based incentives in accordance with the incentive agreement between the incentive rewards system 120 and the particular business 112. According to embodiments, the loyalty-based incentives may have a maximum redemption value which is based, in part, on the customer's previous transactional activity between the customer 102 and the business 112.

From operation 408, the routine 400 proceeds to operation 410, where the incentive pricing module 280 may be configured to determine the price of the loyalty-based incentive based on the redemption value of the loyalty-based incentive. As described above with respect to FIG. 3, the purchase price of the loyalty-based incentive is typically a percentage of the redemption value of the loyalty-based incentive.

From operation 410, the routine 400 proceeds to operation 412, where the incentive rewards system 120 presents the loyalty-based incentive to the customer for purchase. From operation 412, the routine 400 proceeds to operation 414, where the incentive rewards system 120 receives payment information from the customer 102 for the purchase of the loyalty-based incentive. From operation 414, the routine 400 proceeds to operation 416, where the incentive rewards system 120 provides the loyalty-based incentive to the customer 102 for use at the participating business 112. From operation 416, the routine 400 proceeds to operation 418, where the routine 400 ends.

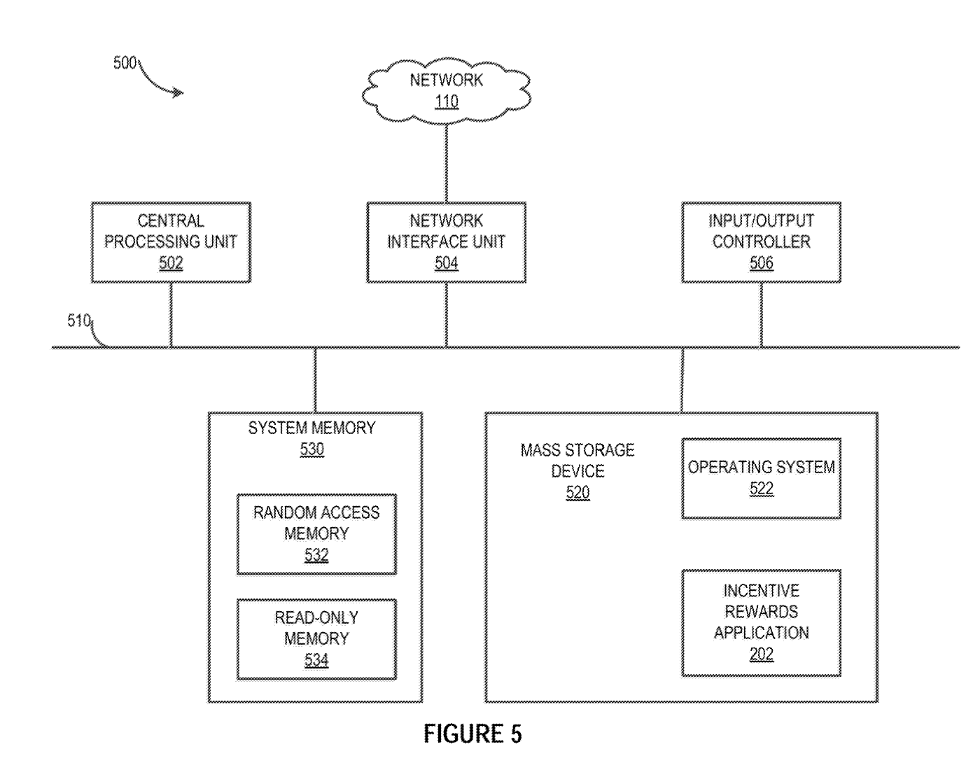

The computer architecture illustrated in FIG. 5 can include a central processing unit 502 (CPU), a system memory 530, including a random access memory 532 (RAM) and a read-only memory 534 (ROM), and a system bus 510 that can couple the system memory 530 to the CPU 502. A basic input/output system containing the basic routines that help to transfer information between elements within the computer architecture 500, such as during startup, can be stored in the ROM 534. The computer architecture 500 may further include a mass storage device 520 for storing an operating system 522, software, data, and various program modules, such as the incentive rewards application 202.

The mass storage device 520 can be connected to the CPU 502 through a mass storage controller (not illustrated) connected to the bus 510. The mass storage device 520 and its associated computer-readable media can provide non-volatile storage for the computer architecture 500. Although the description of computer-readable media contained herein refers to a mass storage device, such as a hard disk or CD-ROM drive, it should be appreciated by those skilled in the art that computer-readable media can be any available computer storage media that can be accessed by the computer architecture 500.

By way of example, and not limitation, computer-readable media may include volatile and non-volatile, removable and non-removable media implemented in any method or technology for the non-transitory storage of information such as computer-readable instructions, data structures, program modules or other data. For example, computer-readable media includes, but is not limited to, RAM, ROM, EPROM, EEPROM, flash memory or other solid state memory technology, CD-ROM, digital versatile disks (DVD), HD-DVD, BLU-RAY, or other optical storage, magnetic cassettes, magnetic tape, magnetic disk storage or other magnetic storage devices, or any other medium which can be used to store the desired information and which can be accessed by the computer architecture 500.

According to various embodiments, the computer architecture 500 may operate in a networked environment using logical connections to remote computers through a network such as the network 110. The computer architecture 500 may connect to the network 110 through a network interface unit 504 connected to the bus 510. It should be appreciated that the network interface unit 504 may also be utilized to connect to other types of networks and remote computer systems. The computer architecture 500 may also include an input/output controller 506 for receiving and processing input from a number of other devices, including a keyboard, mouse, or electronic stylus (not illustrated). Similarly, an input/output controller 506 may provide output to a video display, a printer, or other type of output device (also not illustrated).

As mentioned briefly above, a number of program modules and data files may be stored in the mass storage device 520 and RAM 532 of the computer architecture 500, including an operating system 522 suitable for controlling the operation of a networked desktop, laptop, server computer, or other computing environment. The mass storage device 520, ROM 534, and RAM 532 may also store one or more program modules. In particular, the mass storage device 520, the ROM 534, and the RAM 532 may store the incentive rewards application 202 for execution by the CPU 502. The incentive rewards application 202 can include software components for implementing portions of the processes discussed in detail with respect to FIGS. 1-4. The mass storage device 520, the ROM 534, and the RAM 532 may also store other types of program modules.

Software modules, such as the various modules within the incentive rewards application 202 may be associated with the system memory 530, the mass storage device 520, or otherwise. The incentive rewards application 202 may be able to provide loyalty-based incentives to existing customers 102 of participating businesses 112 that are participating in an incentive rewards program 122 administered by the incentive rewards system 120. According to embodiments, the incentive rewards application 202 may be stored on the wireless communications network 100 and executed by a central computing device. In other embodiments, the incentive rewards application 202 may be stored on the network 110 and executed by any computer within the network 110.

The software modules may include software instructions that, when loaded into the CPU 502 and executed, transform a general-purpose computing system into a special-purpose computing system customized to facilitate all, or part of, loyalty-based incentives generation and distribution techniques disclosed herein. As detailed throughout this description, the program modules may provide various tools or techniques by which the computer architecture 500 may participate within the overall systems or operating environments using the components, logic flows, and/or data structures discussed herein.

The CPU 502 may be constructed from any number of transistors or other circuit elements, which may individually or collectively assume any number of states. More specifically, the CPU 502 may operate as a state machine or finite-state machine. Such a machine may be transformed to a second machine, or specific machine by loading executable instructions contained within the program modules. These computer-executable instructions may transform the CPU 502 by specifying how the CPU 502 transitions between states, thereby transforming the transistors or other circuit elements constituting the CPU 502 from a first machine to a second machine, wherein the second machine may be specifically configured to administer a loyalty-based incentive rewards program. The states of either machine may also be transformed by receiving input from one or more user input devices associated with the input/output controller 506, the network interface unit 504, other peripherals, other interfaces, or one or more users or other actors. Either machine may also transform states, or various physical characteristics of various output devices such as printers, speakers, video displays, or otherwise.

Encoding of the program modules may also transform the physical structure of the storage media. The specific transformation of physical structure may depend on various factors, in different implementations of this description. Examples of such factors may include, but are not limited to: the technology used to implement the storage media, whether the storage media are characterized as primary or secondary storage, and the like. For example, if the storage media are implemented as semiconductor-based memory, the program modules may transform the physical state of the system memory 530 when the software is encoded therein. For example, the software may transform the state of transistors, capacitors, or other discrete circuit elements constituting the system memory 530.

As another example, the storage media may be implemented using magnetic or optical technology. In such implementations, the program modules may transform the physical state of magnetic or optical media, when the software is encoded therein. These transformations may include altering the magnetic characteristics of particular locations within given magnetic media. These transformations may also include altering the physical features or characteristics of particular locations within given optical media, to change the optical characteristics of those locations. It should be appreciated that various other transformations of physical media are possible without departing from the scope and spirit of the present description.

Based on the foregoing, it should be appreciated that technologies for administering a loyalty-based incentive rewards program that provides loyalty-based incentives to existing customers of a business participating in an incentive rewards program are presented herein. Although the subject matter presented herein has been described in language specific to computer structural features, methodological acts, and computer readable media, it is to be understood that the invention defined in the appended claims is not necessarily limited to the specific features, acts, or media described herein. Rather, the specific features, acts and mediums are disclosed as example forms of implementation.

The subject matter described above is provided by way of illustration only and should not be construed as limiting. Various modifications and changes may be made to the subject matter described herein without following the example embodiments and applications illustrated and described, and without departing from the true spirit and scope of the present invention.

1.-15. (canceled)

16. A computer-readable storage medium having computer-executable instructions stored thereon, which when executed by a computer, cause the computer to:
maintain, by a computer, for a customer, a plurality of business-specific loyalty accounts via a single customer account, the plurality of business-specific loyalty accounts comprising
i) a first business-specific loyalty account including transaction history corresponding to transactions made by the customer at a first business and a first incentive acquisition history corresponding to incentives acquired by the customer for redemption only at the first business; and
ii) a second business-specific loyalty account including transaction history corresponding to transactions made by the customer at a second business and a second incentive acquisition history corresponding to incentives acquired by the customer for redemption only at the second business;
determine whether the customer is eligible for a loyalty-based incentive based on the transaction history of the customer with the first business;
upon determining that the customer is eligible for the loyalty-based incentive, determine, via the computer, a redemption value of the incentive for which the customer is eligible based only on the transaction history and the first incentive acquisition history corresponding to the first business, wherein the transaction history comprises a total amount of money spent at the first business and the first incentive acquisition history comprises a total amount of incentives corresponding to the first business that were previously acquired by the customer;
receive, from the customer, consideration in exchange for the loyalty-based incentive; and upon receiving consideration from the customer, provide, to the customer, the loyalty-based incentive redeemable only at the first business.

17. The computer-readable storage medium of claim 16, comprising further computer-executable instructions stored thereon, which when executed by the computer, cause the computer to:
receive, from the customer, a payment corresponding to the loyalty-based incentive; and
generate the loyalty-based incentive having the corresponding redemption value.

18. The computer-readable storage medium of claim 16, comprising further computer-executable instructions stored thereon, which when executed by the computer, cause the computer to receive a request for a particular type of loyalty-based incentive and a desired redemption value of the loyalty-based incentive.

19. The computer-readable storage medium of claim 16, comprising further computer-executable instructions stored thereon, which when executed by the computer, cause the computer to:
generate a plurality of loyalty-based incentives having corresponding redemption values;
determine a corresponding purchase price for each of the plurality of loyalty-based incentives; and
present, to the customer, at least one of the plurality of loyalty-based incentives having a corresponding redemption value for purchase along with a corresponding purchase price.

20. The computer-readable storage medium of claim 16, wherein determining, via the computer, whether the customer is eligible for the loyalty-based incentive comprises determining if the customer has previously conducted a business transaction with the first business for which the loyalty-based incentive is requested.

21. A method for implementing a multi-business loyalty-based incentive rewards program to increase customer retention rates at participating businesses by incentivizing customers of a particular participating business to return to the same participating business by providing a business-specific loyalty-based incentive that can only be redeemed at the same particular participating business, the method comprising:
maintaining, by an incentive rewards system executing on one or more computing devices, for a first user, a plurality of business-specific loyalty accounts via a single user account, the plurality of business-specific loyalty accounts comprising
i) a first business-specific loyalty account including purchase history corresponding to purchases made by the first user at a first business and a first incentive acquisition history corresponding to incentives acquired by the first user for redemption only at the first business; and
ii) a second business-specific loyalty account including purchase history corresponding to purchases made by the first user at a second business and a second incentive acquisition history corresponding to incentives acquired by the first user for redemption only at the second business;
determining, by the incentive rewards system executing on the one or more computing devices, a redemption value of the first business-specific incentive and a monetary price corresponding to the redemption value of the first business-specific incentive based only on the purchase history and the first incentive acquisition history corresponding to the first business, wherein the purchase history comprises a total amount of money spent at the first business and the first incentive acquisition history comprises a total amount of incentives corresponding to the first business that were previously acquired by the customer; and
providing, to the first user, the first business-specific incentive that is redeemable only at the first business in response to receiving the monetary price from the first user.

22. The method of claim 21, further comprising:
receiving, from the first user, an indication of a store purchase at the first business including a purchase amount;
responsive to receiving the indication of a store purchase from the first user, updating the purchase history of the first business-specific loyalty account to include the purchase amount corresponding to the received indication of the store purchase.

23. The method of claim 22, wherein the indication of the store purchase comprises a proof of purchase and wherein the indication of the store purchase is received from a user device corresponding to the user.

24. The method of claim 22, wherein determining a redemption value of the first business-specific incentive and a monetary price corresponding to the redemption value of the first business-specific incentive comprises calculating using only the purchase history of the updated first business-specific loyalty account corresponding to store purchases made by the first user at the first business.

25. The method of claim 22, further comprising:
responsive to determining a redemption value of the first business-specific incentive and a monetary price corresponding to the redemption value of the first business-specific incentive, providing, to the first user, an opportunity to acquire the first business-specific incentive having the determined redemption value at the determined monetary price;
responsive to providing the opportunity, receiving, from the first user, a payment corresponding to the monetary price corresponding to the first business-specific incentive; and
responsive to receiving the payment from the first user, updating the first incentive acquisition history of the first business-specific loyalty account to include the redemption value of the first business-specific incentive acquired.

26. The method of claim 25, wherein providing, to the first user, an opportunity to acquire the first business-specific incentive comprises providing an opportunity to acquire the first business-specific incentive for a predetermined period of time from a time the store purchase is made.

27. The method of claim 25, wherein providing, to the first user, an opportunity to acquire the first business-specific incentive comprises providing an opportunity to acquire the first business-specific incentive for a predetermined period of time from the time the indication of the store purchase is received.

28. The method of claim 25, further comprising:
receiving, from the first user, an indication of a second store purchase at the second business including a second purchase amount, wherein the indication of the second store purchase comprises a second proof of purchase and wherein the indication of the second store purchase is received from the user device corresponding to the user;
responsive to receiving the indication of the second store purchase from the first user, updating the purchase history of the second business-specific loyalty account to include the second purchase amount corresponding to the received indication of the second store purchase;
determining a second redemption value and a second monetary price corresponding to the second redemption value of the second business-specific incentive using only the purchase history of the updated second business-specific loyalty account corresponding to purchases made by the first user at the second business;
providing, to the first user, an opportunity to acquire the second business-specific incentive having the second redemption value at the second monetary price;
receiving, from the first user, a second payment corresponding to the second monetary price corresponding to the second business-specific incentive;
responsive to receiving the second payment from the first user, updating the second incentive acquisition history of the second business-specific loyalty account to include the second redemption value of the second business-specific incentive acquired; and
providing, to the first user, the second business-specific incentive that is redeemable only at the second business.

29. A system for implementing a multi-business loyalty-based incentive rewards program to increase customer retention rates at participating businesses by incentivizing customers of a particular participating business to return to the same participating business by providing a business-specific loyalty-based incentive that can only be redeemed at the same particular participating business, comprising:
an incentive rewards system executing on one or more computing devices, the incentive rewards system configured to
maintain, for a first user, a plurality of business-specific loyalty accounts via a single user account, the plurality of business-specific loyalty accounts comprising
i) a first business-specific loyalty account including purchase history corresponding to purchases made by the first user at a first business and a first incentive acquisition history corresponding to incentives acquired by the first user for redemption only at the first business; and
ii) a second business-specific loyalty account including purchase history corresponding to purchases made by the first user at a second business and a second incentive acquisition history corresponding to incentives acquired by the first user for redemption only at the second business;
wherein the incentive rewards system
determines a redemption value of the first business-specific incentive and a monetary price corresponding to the redemption value of the first business-specific incentive based only on the purchase history and the first incentive acquisition history corresponding to the first business, wherein the purchase history comprises a total amount of money spent at the first business and the first incentive acquisition history comprises a total amount of incentives corresponding to the first business that were previously acquired by the customer; and
provides, to the first user, the first business-specific incentive that is redeemable only at the first business in response to receiving the monetary price from the first user.

30. The system of claim 29, wherein the incentive rewards system is further configured to:
receive, from the first user, an indication of a store purchase at the first business including a purchase amount;
responsive to receiving the indication of a store purchase from the first user, updating the purchase history of the first business-specific loyalty account to include the purchase amount corresponding to the received indication of the store purchase.

31. The system of claim 29, wherein the indication of the store purchase comprises a proof of purchase and wherein the indication of the store purchase is received from a user device corresponding to the user.

32. The system of claim 29, wherein the incentive rewards system is further configured to determine a redemption value of the first business-specific incentive and a monetary price corresponding to the redemption value of the first business-specific incentive comprises calculating using only the purchase history of the updated first business-specific loyalty account corresponding to store purchases made by the first user at the first business.

33. The system of claim 32, wherein the incentive rewards system is further configured to:
responsive to determining a redemption value of the first business-specific incentive and a monetary price corresponding to the redemption value of the first business-specific incentive, provide, to the first user, an opportunity to acquire the first business-specific incentive having the determined redemption value at the determined monetary price;
responsive to providing the opportunity, receive, from the first user, a payment corresponding to the monetary price corresponding to the first business-specific incentive; and
responsive to receiving the payment from the first user, update the first incentive acquisition history of the first business-specific loyalty account to include the redemption value of the first business-specific incentive acquired.

34. The system of claim 33, wherein providing, to the first user, an opportunity to acquire the first business-specific incentive comprises providing an opportunity to acquire the first business-specific incentive for a predetermined period of time from the time the indication of the store purchase is received.

35. The system of claim 29, wherein, the incentive rewards system is further configured to:
receive, from the first user, an indication of a second store purchase at the second business including a second purchase amount, wherein the indication of the second store purchase comprises a second proof of purchase and wherein the indication of the second store purchase is received from the user device corresponding to the user;
responsive to receiving the indication of the second store purchase from the first user, update the purchase history of the second business-specific loyalty account to include the second purchase amount corresponding to the received indication of the second store purchase;
determine a second redemption value and a second monetary price corresponding to the second redemption value of the second business-specific incentive using only the purchase history of the updated second business-specific loyalty account corresponding to purchases made by the first user at the second business;
provide, to the first user, an opportunity to acquire the second business-specific incentive having the second redemption value at the second monetary price;
receive, from the first user, a second payment corresponding to the second monetary price corresponding to the second business-specific incentive;
responsive to receiving the second payment from the first user, update the second incentive acquisition history of the second business-specific loyalty account to include the second redemption value of the second business-specific incentive acquired; and
provide, to the first user, the second business-specific incentive that is redeemable only at the second business.
